(19) United States
(12) Patent Application Publication
(10) Pub. No.: US 2005/0184667 A1
(43) Pub. Date: Aug. 25, 2005

(54) CCFL illuminated device and method of use

(76) Inventors: Bruce D. Sturman, New York, NY (US); Ian C. Murray, New York, NY (US)

Correspondence Address: TORYS LLP, 79 WELLINGTON ST. WEST, SUITE 3000, TORONTO, ON, M5K 1N2, CA

(21) Appl. No.: 10/809,310

(22) Filed: Mar. 26, 2004

Related U.S. Application Data
(63) Continuation-in-part of application No. 10/414,714, filed on Apr. 15, 2003, now Pat. No. 6,793,381.
Application No. 10/414,714 is a continuation of application No. 09/598,009, filed on Jun. 20, 2000, now Pat. No. 6,616,310.
Application No. 09/598,009 is a continuation-in-part of application No. 08/630,161, filed on Apr. 10, 1996, now abandoned.

(51) Int. Cl. H01J 23/16

(52) U.S. Cl. 315/59; 315/55; 315/60

(57) ABSTRACT

A Cold Cathode Fluorescent Lamp (CCFL) is enclosed within a bulb normally used for incandescent fixtures. The CCFL is bent into a u-shape to fit within the bulb and the ballast can be installed in the lamp base. In an alternative embodiment, one or more CCFLs is enclosed within a fluorescent lamp tube or bulb with bi pin end caps. An insert in the end cap can support the CCFLs. Contact is made to the CCFLs through a connection with the pins of the end caps. In an alternative arrangement, the CCFLs are supported within the tube by electrode wires connecting to the pins.

This is a continuation-in-part of U.S. patent application Ser. No. 10/414,714, which is a continuation of U.S. patent application Ser. No. 09/598,009, filed Jun. 20, 2000, which is a continuation-in-part of U.S. patent application Ser. No. 08/630,161 filed Apr. 10, 1996, now U.S. Pat. No. 6,135,620, issued Oct. 24, 2000.

### FIELD OF INVENTION

This invention relates generally to miniature cold cathode fluorescent lamps (CCFLs) and other miniature fluorescent lamps, associated devices and methods of use, and more specifically, to lighting devices utilizing CCFL-type devices in conjunction with novel connectors, mounting brackets, housings and other accessories to provide new and unique lighting devices and methods of using them, all of which offer significant savings in cost, operating expense, power consumption and retrofit convenience.

### BACKGROUND OF THE INVENTION

Electrically powered exit signs, traffic signals, task lights and other devices are widely used. Fluorescent lamps are used to provide illumination in typical electrical devices for general lighting purposes because they are more efficient than incandescent bulbs in producing light. A fluorescent lamp is a low pressure gas discharge source, in which light is produced predominantly by fluorescent powders activated by ultraviolet energy generated by a mercury plasma forming an arc. The lamp, usually in the form of a tubular bulb with an electrode sealed into each end, contains mercury vapor at low pressure with a small amount of inert gas for starting. The inner walls of the bulb are coated with fluorescent powders commonly called phosphors. When the proper voltage is applied, the plasma forming an arc is produced by current flowing between the electrodes through the mercury vapor. This discharge generates some visible radiation. The ultraviolet in turn excites the phosphors to emit light.

Two electrodes are hermetically sealed into the bulb, one at each end. These electrodes are designed for operating as either “cold” or “hot” cathodes or electrodes, more correctly called glow or arc modes of discharge operation. Electrodes for glow or cold cathode operation may consist of closed-end metal cylinders, generally coated on the inside with an emissive material. Conventional cold cathode lamps operate at a current on the order of a few hundred milliamperes, with a high cathode fall or voltage drop, something in excess of 50 volts. CCFLs are not appreciably affected by starting frequency because of the type of electrode used CCFLs emit light in the same way as to standard hot electrode lamps. The latter type operate as normal glow discharges and their electrodes are uncoated hollow cylinders of nickel or iron. The cathode fall is high and to obtain high efficacy or power for general lighting purposes, conventional lamps are made fairly long, about 2-8 feet, with a diameter of about 25-40 millimeters. About 2000 volts is required for starting these conventional lamps and about 900 to 1000 volts for running.

The advantages of CCFLs compared with the hot electrode fluorescent lamps are that they have a very long life (usually) 15000 hours or more) in consequence of their rugged electrodes, lack of filament and low current consumption. They start immediately, even under cold ambient conditions. Their life is unaffected by the number of starts. Also, they may be dimmed to very low levels of light output.

U.S. Pat. No. 4,650,265 issued Mar. 17, 1987 to Holtzman teaches an illuminating lamp assembly for retrofitting an exit sign. This invention is directed towards a retrofit system with a rotatably threaded electrical connector for interfacing with an existing standard home-type incandescent light bulb electrical socket and a standard non-CCFL bulb and retaining arms configuration horizontally and rotatably mounted to the electrical connector.

U.S. Pat. No. 5,018,290 issued May 28, 1991 to Kozek et al. teaches an exit sign with a plurality of low voltage incandescent lamps mounted on a printed circuit board to provide illumination from within a housing. Stenciled images are used on the external, semi-transparent housing surfaces.

U.S. Pat. No. 5,365,411 issued Nov. 15, 1994 to Rycroft et al. teaches exit signs with illumination. Arrays of light emitting diodes are disposed in spaced relationship above a rear wall configured to reflect light emitted from the diodes relatively uniformly across a diffuser which further contributes to relative uniform transmission of light therethrough. The system uses low direct voltage diodes.

U.S. Pat. No. 5,388,357 issued Feb. 14, 1995 to Malita teaches a kit using LED units for retrofitting illuminated signs. The kit retrofits a conventional exit sign, which normally uses internally mounted incandescent or fluorescent lamps, to operate using multiple LED sources in a group or assembly on a board. Indicia lighting is accomplished substantially indirectly through reflection of light from the LED sources which are powered through an adapter that fits into the socket of the original incandescent lamp or fluorescent lamp which is removed in the retrofit process.

U.S. Pat. No. 5,410,453 issued Apr. 25, 1995 to Ruskouski teaches a lighting device used in an exit sign. A light emitting diode lighting device is provided for mating engagingly with an electrical socket of the lighting fixture. The light emitting diode device has a plurality of LEDs recessed in frustoconical apertures for directing light into a desired illumination pattern.

U.S. Pat. No. 5,416,679 issued May 16, 1995 to Ruskouski et al. teaches a mounting base assembly for a lighting device used in an exit sign. In the lighting fixture such as an exit sign, a mounting base assembly is provided on a light emitting diode lighting device for mating engagement with an electrical socket. Once full mating engagement is achieved between the electrical socket and a base member of the mounting base assembly, the position of the housing carrying the light emitting diodes of the lighting device can be adjusted for alignment purposes without disturbing the full mating engagement of the electrical socket and the base member.

U.S. Pat. No. 5,428,515 issued Jun. 27, 1995 to Jung teaches an electric lighting assembly. The assembly included a protective holder formed on the top with two holes and at two opposite sides with depending lugs, said lugs having a hook portion at the lower end, a ring contact secured on the top of said protective holder. A contact is provided on the top with a tip contact and the outer peripheral wall with spiral threads, said tip contact and said spiral threads being electrically connected with the two holes of said protective holder, a conical member connected with the two holds of said p protective holder and supported by the hook of said lugs, and a neon light bulb connected with said conical member, whereby the neon light can be used indoors.

U.S. Pat. No. 5,440,467 issued Aug. 8, 1995 to Lautzenheiser teaches a task light. The light assembly is provided for illuminating a work surface below and in front of the light assembly, and includes a housing configured for mounting over the work surface with an elongated linear light source supported in its housing. A tubular lens is built into and part of the housing, and includes prism-shaped triangular rings on its inside surface for controlling the light from the light source onto the work surface therebelow.

CCFLs emit white light omnidirectionally, while combining low power consumption, long lamp lives, and low maintenance requirements similar to LEDs. Light outputs remain constant for all colors, not like LEDs whose light output varies with each color. The omnidirectional white light output is a key factor in the present invention.

### SUMMARY OF THE INVENTION

The invention includes a cold cathode fluorescent lamp (CCFL) illuminated A-lamp shaped light bulb, the bulb having a base adapted to utilizing a main power source. A CCFL having a predetermined length and geometric configuration is fitted within the bulb envelope. The A-lamp shaped body portion is made of a suitable transparent material. Within the bulb there are CCFL mounting means for grasping the CCFL securely.

Ballast means are provided comprising an electrical circuit and associated electronics including control means. The ballast means have an input and an output, the input being adapted to connect to the main source of electrical power, the output being connected to the CCFL electrodes. The ballast means receive a predetermined electrical input and produce electrical outputs sufficient to stimulate the CCFL to produce illumination.

The bulb mounting socket base portion has a predetermined geometric configuration adapted to fit into conventional candelabra sockets. The bulb mounting socket base portion has a pair of electrical contacts., The contacts connect to the input of the ballast and are configured like the contacts on the base of a conventional incandescent A-lamp light bulb. In the preferred embodiment, the CCFL is bent into a U-shape to fit within the bulb envelope.

In an alternative embodiment, one or more cold cathode fluorescent lamps (CCFLs) are enclosed in a single tubular housing which, preferably, is a conventional T-5 fluorescent bulb with a conventional bi-pin connection at each end. In this embodiment, the electrodes at each end of the CCFLs can be connected in parallel and coupled to a either or both pins of the T-5 bulb. A conventional fluorescent bulb socket pair can be wired to provide a voltage drop. A support structure stabilizes the CCFL within the housing. The leads which connect to the sockets are connected to a ballast which in turn is connected to a source of power.

Numerous other advantages and features of the present invention will become readily apparent from the following detailed description of the invention and the embodiments thereof, from the claims and from the accompanying drawings in which the details of the invention are fully and completely disclosed as a part of this specification.

### BRIEF DESCRIPTION OF THE DRAWINGS

FIG. 1 is a perspective view of an A-lamp light bulb of the present invention;

FIG. 2 is a cross section of an A-lamp light bulb with CCFL and associated electronics;

FIG. 3 is a perspective view of an alternative embodiment with a CCFL mounted within a bi-pin T-5 bulb;

FIG. 4 is a side view of another alternative embodiment with a pair of CCFLs mounted within a bi-pin T-5 bulb; and

FIG. 5 is a view of the embodiment of FIG. 3 with the associated electrical connections.

### DETAILED DESCRIPTION OF THE INVENTION

FIG. 1 is a perspective view of an A-lamp light bulb 10 of the present invention. The A-lamp shape is well known and the electrode configuration with the socket is well known. Thus, by providing the same shape bulb or envelope portion 12, the present invention will be immediately useful wherever common incandescent bulbs are used. The base portion 14 is the same size and shape as the common incandescent bulb socket portion. The CCFL lamp 16 has a single U-shaped bend in the middle. A plurality of bends or CCFL lamps of different geometries would also be within the scope of the present invention and would be known to those skilled in the art. It will also be understood that a tubular housing 18 may or may not be necessary or desirable, depending upon the end use of the bulbs and the environment in which it is to operate.

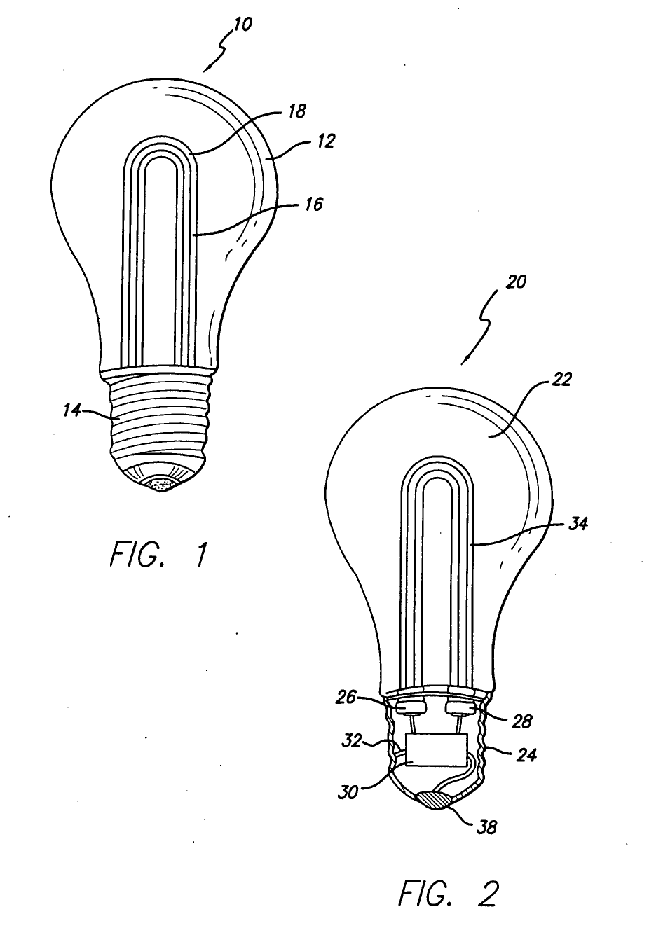

FIG. 2 is a cross section of an A-lamp light bulb 20 with a CCFL device, associated electronics and internal mounting means of the present invention. In cross section, the bulb portion 22 is coupled to the base portion 24. The base portion is comprised of first and second electrically-isolated low-voltage electrodes 26, 28 which are integral with the threaded mounting socket base portion. These low-voltage electrodes are designed to electrically couple with the line power of the standard A-lamp light or appliance socket. The ballast element 30 will be small enough to be placed in the base portion 24 of the bulb 30. Connected to the ballast 30 are CCFL electrodes 32 which extend from either end of the U-shaped CCFL lamp 34.

As shown, one of the ballast 30 inputs is connected to the conductive wall 36 of the base portion 24 and the other input is connected to the central contact 38 of the base portion 24. The outputs of the ballast 24 are connected to the electrodes 32 of the CCFL and, when connected to a source of power, provide the necessary voltage to energize the CCFL.

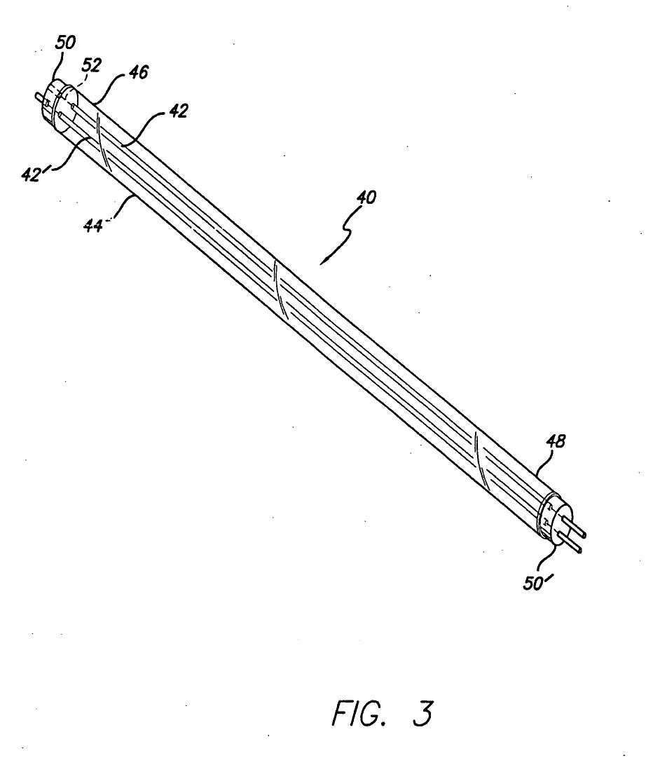

FIG. 3 is a perspective view of an alternative embodiment of a CCFL lamp assembly 40 of the present invention. The assembly consists of a pair of CCFLs 42, 42′ held inside an outer tubular housing 44 at a first end 46 and a second end 48. Preferably, the tubular housing is a conventional T-5 fluorescent tube lamp without phosphor or electrodes. The tube lamp itself functions as the protective tubular housing for the more fragile CCFL lamps 42, 42′ mounted therein. While the preferred alternative embodiment uses two CCFLs, other embodiments might use just a single CCFL.

The CCFLs 42, 42′ are supported and held in place inside bi pin end fittings 50, 50′. These end fittings 50, 50′ can be any type of fitting which will hold the CCFLs in place, preferably with some degree of support to protect against shock and vibration. In a preferred embodiment, they consist of rubber or plastic inserts 52 in the end fittings 50, 50′ so that the CCFL contact lead wires 54, which extend from the CCFL electrodes can extend to the pins of the fitting 50, 50′ for electrical connection to the CCFLs 42, 42′ and permit the fitting 50 to seal the end of the tubular housing 44. The CCFLs 42, 42′ are supported inside the inserts 52 and contact lead wires 54 are in electrical contact with the electrodes of the CCFLs.

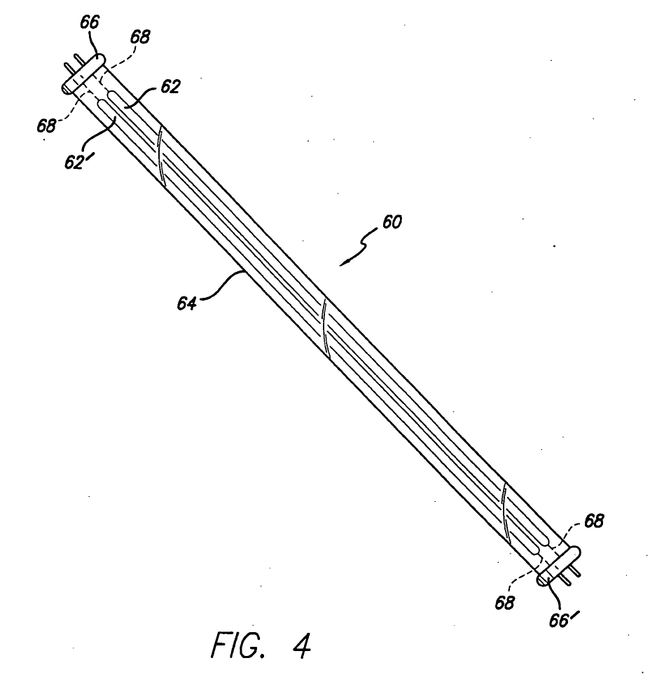

FIG. 4 is a perspective view of an alternative embodiment 60 of a light assembly of the present invention for use in general lighting applications. Similar to the embodiment of FIG. 3, the light assembly 60 includes a pair of CCFLs 62, 62′ inside a protective tubular housing 64, which, as in the embodiment of FIG. 3, is a T-5 fluorescent tube without phosphors or electrodes. More or less conventional bi pin end fittings 66, 66′ enclose the ends of the outer tubular housing 64. The electrical contacts 68 to the CCFL electrodes extend to the pins of the end fittings 66, 66′ and may be adequate to suspend and support the CCFLs 62, 62′ without the need of inserts similar to those of FIG. 3.

While the embodiment of FIG. 4 has been shown with two CCFLs, it is clear that the present invention can be practiced using only one CCFL. In addition, other tubular structures, such as are used in other tubular fluorescent lamps, may be employed as protective coverings for the relatively fragile CCFLs. The use of more or less conventional bi-pin end fittings enables the lamp assembly of the present invention to be easy replacements for conventional fluorescent lamps and the conventional sockets can easily be rewired to accommodate the operating requirements of the CCFLs. The scope of the invention should, therefore, be limited only by the scope of the claims appended hereto.

1-6. (canceled)

7. A light assembly comprising;
a. A fluorescent tube bulb;
b. A CCFL wholly contained within said fluorescent tube bulb including electrodes at each end extending from the interior to the exterior of said CCFL;
c. A bi-pin end cap at each end of said fluorescent tube bulb; and
d. Connecting means electrically coupling said CCFL electrodes to at least one pin of each of said bi-pin end caps,
whereby electrical energy applied to said bi-pin end caps in transmitted to energize said CCFL.

8. The light assembly of claim 7, above, wherein said bi-pin end caps include support means for holding said CCFL.

9. The light assembly of claim 7, above further including a second CCFL with electrodes at each end extending from the interior to the exterior of said second CCFL, said second CCFL being wholly contained within said fluorescent tube bulb; ans said connecting means coupling the pins of said bi pin end caps to both of said CCFLs.

10. The light assembly of claim 9, above, wherein said bi-pin end caps include support means for suspending both of said CCFLs.
